(19) United States
(12) Patent Application Publication
(10) Pub. No.: US 2009/0228553 A1
(43) Pub. Date: Sep. 10, 2009

(54) Trouble Report System Algorithm

(75) Inventor: Rachele Barbara Cocks, Fort Wayne, IN (US)

Correspondence Address: Rachele Cocks, 3086 E. - 675 N., Huntington, IN, 46750, US

(73) Assignee: Venture Alliance Systems and Technology, LLC, Huntington, IN (US)

(21) Appl. No.: 12/044,956

(22) Filed: Mar. 8, 2008

(51) Int. Cl. G06F 15/16

(52) U.S. Cl. 709/204

(57) ABSTRACT

A Trouble Report System Algorithm will provide a means for users to voice a concern or recognized issue for review, evaluation, and solution by others involved and/or responsible for the given project, who's identity will also be kept anonymous.

### BACKGROUND OF THE INVENTION

The present invention is in the technical field of business methods.

More particularly, the present invention is in the technical field of decision aiding technology and risk prevention technology.

### BRIEF SUMMARY OF THE INVENTION

The present invention is a Trouble Report System Algorithm. This is a algorithm designed to provide a means for anonymous trouble or issue reporting. The algorithm also provides a means for review of the identified issue keeping anonymity as a main feature through issue identification, issue review, and issue solution. The main value of this algorithm is its ability to maintain user anonymity through an issue identification, issue review or validation, through the solution of the issue. The Trouble Report System will also maintain a record of recognized issues for future review maintaining anonymity for involved parties.

### DETAILED DESCRIPTION OF THE INVENTION

The Trouble Report System Algorithm design is focused for use in software. This algorithm, for a given user group, will provide a means for users to anonymously input issue reports for problems that are recognized for a given project, to be evaluated by series of selected user groups. The input interface will be accessible to all users in this defined group. Groups will be defined by algorithm user and should include all individuals that would have any interest or responsibility for the project that in consideration for the Trouble Report System Algorithm.

When the identified issue is put into the system, via a report ticket, the user will have a variety of fields to select the most appropriate specification for. These fields include, but are not limited to, business or company division, priority level, department, and description. These fields will be determined specifically for the user group and associated project and can be added to or detracted from as would be needed for the user group and project. The identified issue, clearly defined in the report ticket, will be forwarded by a group of reviewers chosen by the Trouble report system algorithm.

The trouble report system algorithm will create review groups will be modified specifically for the user group and project of interest. The consistent properties of this selection process will include the following; review groups will always be comprised of an odd number of reviewers, review groups will be chosen according to a relative numerical assignment to the project determining their overall expertise and ability to address the given issue according to the issuers defined fields in original report ticket, review groups will be assigned in levels starting with an initial review group composed of three users to the maximum allowable group of reviewers possible determined by the total number of users and the number of previous review groups, quantitative value assignments for the user's assessment could include, for example, but are not limited to merit, manager review of employee, education, and relevant experience, variation in each level of review group will vary with respect to total included user group size for the given project, and members of the review groups will be kept anonymous from each other.

Once the report ticket is forwarded to review group, they have the following options for response.
1. Invalidate and support with description, relevant data, and support.
2. Forward to next review group due to inadequate knowledge, experience, and/or judgment.
3. Return to initiator if more information is needed.—at which point initiator has allotted time period to respond before returned to sender from review group. When sender receives a ticket back without information needed, depending on the other review groups responses, ticket will be forwarded to department responsible for issue, for the information to be added. Others in review group are notified of the additional information that was requested and can also add response if they have the information requested. If ticket is in first review groups queue with out the proper information or response in allotted time, ticket will automatically move to the next review group for review. Same rules will apply.
4. Propose solution and forward to group responsible. For implementation and sign off.
5. Send ticket to emergency status, alerting highest-level review group.
   The following conditions apply to a report ticket in process.
1. If ticket cannot be solved for highest-level review group, responsible group and randomly generated review group become final review solution group. Project is stopped, review and solution group have option to have anonymous meeting or in person meetings to solve issue. Program will still provide anonymity as previous solution groups are not revealed since final review solution group is randomly selected.
2. To invalidate a solution majority of review group must provide invalidation.
3. If ticket is invalidated it is moved to a database of tickets, invalidated tickets, validated tickets with response and/or solutions will be stored in database along with in process tickets. Tickets will be searchable by status, department, severity, date (entered/ solved/ etc), keyword, and time in queue as well as other fields defined for the project.
4. Ticket initiator has option to reference other tickets in database for reference, support or rebuttal.
5. Tickets in database can be resubmitted with new explanation and concern by initiator.
6. The flow of the report ticket can be altered with respect to the project timeline progression. The project timeline will be entered and can be modified by an assigned administrator or administrator group, and will be monitored by the Trouble report system. Stage assignments will be made to the project timeline line, including but not limited to, a critical and caution stage. The caution stage will alert the users that the project is entering or in a critical stage requiring increased attentiveness. The critical stage will be a set time before project implementation where decisions made will be critical to projects success. When the project is considered to be in the caution stage, tickets will have a set time in a review group's queue, after which time the ticket will be forwarded to the next created review group. In the critical stage, the time a report ticket will remain in a review group's queue will decrease exponentially with respect to the projects determined implementation time.

The advantages of the present invention include, without limitation, a user to express freely, in anonymity, a concern or observation to be reviewed by others involved in project.

In broad embodiment, the present invention is an algorithm created for a system that will provide anonymity for users who wish to voice a concern with out the knowledge of their identity. The anonymity of all parties in the processing of an issue (report ticket) will be kept.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A method of providing a modified structure for a given social network with the purpose of creating direct lines for information flow to members of network that are determined to have increased knowledge and understanding of the given issue that is defined to be of interest.

2. A method to provide users a means to report issues, under anonymity, so that the issues are viewable by all parties in an interest group, while issue is being processed through a path of various review groups, with anonymity provided for all parties involved.

3. A method to force the review of a recognized issue by review groups that are created specifically for each recognized issue and by providing a record of issues.
